(19) United States
(12) Patent Application Publication
(10) Pub. No.: US 2024/0204256 A1
(43) Pub. Date: Jun. 20, 2024

(54) ELECTROLYTE COMPOSITIONS

(71) Applicant: Dyson Technology Limited, Wiltshire (GB)

(72) Inventors: Matthew Robert ROBERTS, Oxford (GB); Liyu JIN, Swindon (GB); Yu HU, Swindon (GB); Laís DIAS FERREIRA, Bristol (GB); Niccolo GUERRINI, Oxford (GB); Alex MADSEN, Swindon (GB)

(73) Assignee: Dyson Technology Limited, Wiltshire (GB)

(21) Appl. No.: 18/286,743

(22) PCT Filed: Mar. 22, 2022
(86) PCT No.: PCT/GB2022/050717

§ 371 Date: Oct. 12, 2023

(30) Foreign Application Priority Data
Apr. 15, 2021 (GB) 2105392.1

(51) Int. Cl. H01M 10/0569; H01M 10/0525; H01M 10/0567; H01M 10/0568; H01M 10/058

(52) U.S. Cl. CPC H01M 10/0569; H01M 10/0525; H01M 10/0567; H01M 10/0568; H01M 10/058; H01M 2300/0037

(57) ABSTRACT

An electrolyte composition for a lithium ion battery. The composition includes 5-25 wt % of lithium salt, 2-10 wt % of additive and 65-93 wt % of solvent. The lithium salt includes 20-100 mol % lithium tetrafluoroborate, and 0-95 mol % lithium bis(trifluoromethanesulfonyl)imide; (b) the additive includes vinylene carbonate, and optionally 30-90 mol % fluoroethylene carbonate; and (c) the solvent includes 70-90 mol % ethylene carbonate and 10-30 mol % propylene carbonate.

### TECHNICAL FIELD

The present invention relates to electrolyte compositions.

### BACKGROUND

Commercial lithium-ion batteries typically use LiPF₆ as the lithium salt source and linear carbonates e.g. DEC/DMC/EMC as solvents. However, the salt and solvent components used in most commercial Li-ion batteries cannot be processed at elevated temperatures due to thermal decomposition and/or their volatility.

Manufacture of lithium-ion battery components by extrusion is an area of current interest, due to manufacturing costs and throughput rates. Extrusion typically involves processing at elevated temperatures. Other useful processing techniques for battery manufacture which involve elevated temperatures include hot rolling and hot pressing.

### SUMMARY

According to a first aspect of the present invention, there is provided an electrolyte composition for a lithium ion battery, the composition comprising 5-25 wt % of lithium salt, 2-10 wt % of additive and 65-93 wt % of solvent;
and wherein
(a) the lithium salt comprises 20-100 mol % lithium tetrafluoroborate, and 0-95 mol % lithium bis(trifluoromethanesulfonyl)imide;
(b) the additive comprises vinylene carbonate, and optionally 30-90 mol % fluoroethylene carbonate; and
(c) the solvent comprises 70-90 mol % ethylene carbonate and 10-30 mol % propylene carbonate.

The identification of new lithium-ion battery electrolyte compositions is not straightforward. The inventors have identified a series of LiPF₆-free liquid electrolytes with low volatility even at elevated temperatures, which can thus be used in processing techniques which involved elevated temperatures. (LiPF₆ decomposes at such elevated temperatures. It may also be advantageous to avoid using LiPF₆ because it is moisture sensitive, releasing HF on contact with water, and can cause thermal runaway on contact with water). The presently claimed compositions (a) passivate graphite (meaning that graphite can be used as the anode material), (b) are stable at high temperature with a flash point above 100° C., and have a low vapour pressure, and can therefore be extruded (or otherwise processed at elevated temperatures), (c) are stable with respect to common cathode materials, (d) have sufficient ionic conductivity and (e) provide sufficient rate performance.

The invention also provides an extruded battery component comprising an electrolyte composition according to the first aspect, and a method of forming a battery component, including a processing step which requires heating of a composition according to the first aspect to a temperature in excess of about 55° C. Suitably, the processing step may require heating of the composition to a temperature in excess of about 60° C., 70° C. or 80° ° C. In some cases, the processing step requiring heating may include extrusion.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows discharge capacity as function of C-rate with high Ni cathode and natural graphite anode at 30° C. The solid line is data for example 2 and the dashed line is the comparative example. The same batch of electrodes and cell format were used, i.e., the only difference is the electrolyte.

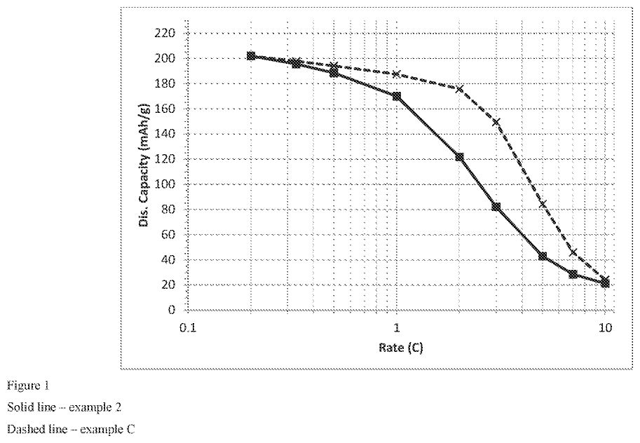

### DETAILED DESCRIPTION

In some cases, the lithium concentration in the electrolyte composition is between about 0.7M and 2.0M.

In some cases, the lithium salt consists of 20-100 mol % lithium tetrafluoroborate, and 0-95 mol % lithium bis(trifluoromethanesulfonyl)imide.

In some cases, the additive consists of (i) vinylene carbonate, or (ii) 10-70 mol % vinylene carbonate and 30-90 mol % fluoroethylene carbonate.

In some cases, the solvent consists of 70-90 mol % ethylene carbonate and 10-30 mol % propylene carbonate.

In some cases, the electrolyte composition is selected from the group consisting of:
a) 7.8 wt % lithium tetrafluoroborate, 69.3 wt % ethylene carbonate, 17.3 wt % propylene carbonate and 5.5 wt % vinylene carbonate;
b) 1.6 wt % lithium tetrafluoroborate, 19.1 wt % lithium bis(trifluoromethanesulfonyl)imide, 55.9 wt % ethylene carbonate, 18.6 wt % propylene carbonate and 4.8 wt % vinylene carbonate;
c) 1.6 wt % lithium tetrafluoroborate, 19.1 wt % lithium bis(trifluoromethanesulfonyl)imide, 54.7 wt % ethylene carbonate, 18.2 wt % propylene carbonate, 4.2 wt % vinylene carbonate and 2.1 wt % fluoroethylene carbonate; and
d) 7.8 wt % lithium tetrafluoroborate, 64.9 wt % ethylene carbonate, 16.2 wt % propylene carbonate and 11.1 wt % vinylene carbonate.

In some such cases, the electrolyte composition is composition d.

The comparative data used in this application relates to the following electrolyte composition, which is known in the art:
1 Molar LiPF₆, in a solvent, the solvent comprising ethylene carbonate and ethylmethylcarbonate in a 1:3 weight ratio.
An additive component was added to this solution; this comprised vinylene carbonate (2 wt %) and fluoroethylene carbonate (0.5 wt %, wt % based on total weight of solution including salt+solvent+additive).

Several electrolyte compositions are described in table 1 below. These have been tested in cells, as described below, to determine the first cycle efficiency and rate capacity at various discharge rates, as illustrated in the figures.

TABLE 1

| | | | Solvents | Additives | | 5 C rate |
|---|---|---|---|---|---|---|
| | | | breakdown | breakdown | | capacity |
| | | | (w/w) and | (w/w) and | First cycle | retention |
| Experiment | Electrolyte | Lithium salt | total solvent | total additive | efficiency | (%) |
| number | composition | wt % | (wt %) | (wt %) | (at 30° C.) | (at 30° C.) |
| C | Comparative | LiPF₆ = 13.4% | EC/EMC = 1:3 | VC/FEC = 4/1 | 89.5 | 39 |
| | data (LiPF6 | | Total = 84.1% | Total = 2.5% | | |
| | Benchmark) | | | | | |
| 1 | LiBF₄ + | LiBF₄ = 7.8% | EC/PC = 4:1 | 5.5 wt % VC | 90 | 13 |
| | EC/PC + VC | | Total = 86.6% | | | |
| 2 | LiBF₄/ | LiBF₄ = 1.6% | EC/PC = 3:1 | 4.8 wt % VC | 85.6 | 17 |
| | LiTFSI + | LiTFSI = 19.1% | Total = 74.5% | | | |
| | EC/PC + VC | | | | | |
| 3 | LiBF₄/ | LiBF₄ = 1.6% | EC/PC = 3:1 | VC/FEC = 2:1 | 85.6 | 14 |
| | LiTFSI + | LiTFSI = 19.1% | Total = 72.9% | | | |
| | EC/PC + | | | Total = 6.3 wt % | | |
| | VC/FEC | | | | | |
| 4 | LiBF₄ + | LiBF₄ = 7.8% | EC/PC = 4:1 | 11.1 wt % VC | 90.1 | 19 |
| | EC/PC + VC | | Total = 81.1% | | | |

The following notation is used in table 1:
LiBF₄: lithium tetrafluoroborate
LiTFSI: lithium bis(trifluoromethanesulfonyl)imide
LiPF6: lithium hexafluorophosphate
EC: ethylene carbonate
PC: propylene carbonate
VC: vinylene carbonate
FEC: fluoroethylene carbonate

Electrochemical evaluations of the electrolytes were carried out with Swagelok or pouch type cells. All the cells have one layer of cathode with areal coating weight over 150 g/m², which consists of over 90 wt % a high nickel NMC active materials and one layer of anode with areal coating weight over 100 g/m², which consists of over 90 wt % graphite/SiOx mixed active materials.

Cell assembly was carried out in a dry-room with Dew point less than −40° C. By design, the nominal capacity was about 3.5 mAh or 40.0 mAh for Swagelok or pouch type cells, respectively. The capacity balance was controlled at about 85-90% utilisation of the anode. For all the cells, glass fibre separators were used and 70 μl or 1 ml of an electrolyte was added for Swagelok or pouch cells, respectively.

All the cells were electrochemically formed at 30° C. A cell was initially charged with a current of C/20 (a current with which it takes 20 hours to fully charge or discharge the cell) for the first hour and then increased to C/10 for the rest of charging until the cell voltage reaching the cut-off voltage of 4.2V. Then the cell is discharged at C/10 until the cut-off voltage of 2.5V. The cell cycles two more cycles with the same cut-off voltages at C/10 for both charging and discharging. The first-cycle efficiency was determined by the first cycle charging capacity divided by first cycle discharging capacity and presented as percentage. Once a cell passed this formation step, rate capability was tested at 30° C. and 45° C., sequentially. The C-rates were calculated based on cathode nominal capacity (active material weight times its theoretical capacity). In a rate capability test, all the charging was carried out at current of C/5 while the discharging ranging from C/10 to 10 C. The rate capacities were thus determined, which can be further normalised by dividing the C/10 capacity from the same test.

In addition to the data presented in table 1, the capacity retention of a cells including electrolyte compositions C and 2 after rate tests at 0.2 C was found to be at or around 100%.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An electrolyte composition for a lithium ion battery, the composition comprising 5-25 wt % of lithium salt, 2-10 wt % of additive and 65-93 wt % of solvent;
and wherein
(a) the lithium salt comprises 20-100 mol % lithium tetrafluoroborate, and 0-95 mol % lithium bis(trifluoromethanesulfonyl)imide;
(b) the additive comprises vinylene carbonate, and optionally 30-90 mol % fluoroethylene carbonate; and
(c) the solvent comprises 70-90 mol % ethylene carbonate and 10-30 mol % propylene carbonate.

2. The electrolyte composition according to claim 1, wherein the lithium concentration in the composition is between about 0.7M and 2.0M.

3. The electrolyte composition according to claim 1, wherein the lithium salt consists of 20-100 mol % lithium tetrafluoroborate, and 0-95 mol % lithium bis(trifluoromethanesulfonyl)imide.

4. The electrolyte composition according to claim 1, wherein the additive consists of (i) vinylene carbonate, or (ii) 10-70 mol % vinylene carbonate and 30-90 mol % fluoroethylene carbonate.

5. The electrolyte composition according to claim 1, wherein the solvent consists of 70-90 mol % ethylene carbonate and 10-30 mol % propylene carbonate.

6. The electrolyte composition according to claim 1, the electrolyte composition selected from the group consisting of:
a) 7.8 wt % lithium tetrafluoroborate, 69.3 wt % ethylene carbonate, 17.3 wt % propylene carbonate and 5.5 wt % vinylene carbonate;
b) 1.6 wt % lithium tetrafluoroborate, 19.1 wt % lithium bis(trifluoromethanesulfonyl)imide, 55.9 wt % ethylene carbonate, 18.6 wt % propylene carbonate and 4.8 wt % vinylene carbonate;
c) 1.6 wt % lithium tetrafluoroborate, 19.1 wt % lithium bis(trifluoromethanesulfonyl)imide, 54.7 wt % ethylene carbonate, 18.2 wt % propylene carbonate, 4.2 wt % vinylene carbonate and 2.1 wt % fluoroethylene carbonate; and
d) 7.8 wt % lithium tetrafluoroborate, 64.9 wt % ethylene carbonate, 16.2 wt % propylene carbonate and 11.1 wt % vinylene carbonate.

7. The electrolyte composition according to claim 6, wherein the electrolyte composition consists of 7.8 wt % lithium tetrafluoroborate, 64.9 wt % ethylene carbonate, 16.2 wt % propylene carbonate and 11.1 wt % vinylene carbonate.

8. An extruded battery component comprising the electrolyte composition according to claim 1.

9. The method of forming a battery component, including a processing step which requires heating the composition according to claim 1 to a temperature in excess of about 55° C.

10. The method according to claim 9, wherein the processing step includes extruding the composition.
